(19) United States
(12) Patent Application Publication
(10) Pub. No.: US 2019/0197567 A1
(43) Pub. Date: Jun. 27, 2019

(54) Consumer behavioral research-as-a-service platform

(71) Applicant: Epicenter Experience, LLC, Carlisle, MA (US)

(72) Inventors: Paul E. Krasinski, Milton, MA (US); Carlton K. Lo, Shrewsbury, MA (US)

(73) Assignee: Epicenter Experience, LLC, Carlisle, MA (US)

(21) Appl. No.: 15/853,081

(22) Filed: Dec. 22, 2017

(51) Int. Cl. G06Q 30/02; G06F 17/30

(52) U.S. Cl. CPC G06Q 30/0203; G06Q 50/01; G06Q 30/0205; G06F 17/30864

(57) ABSTRACT

A method to facilitate consumer behavioral research from end users. When necessary to find sufficiently qualified respondents to meet an audience segment to be surveyed, mobile devices that are or have been in a location of interest are identified (e.g., by their device identifiers). With respect to any device identifier that matches a device identifier in first party data, a query is issued to third party data sources (e.g., advertising networks, exchanges, etc.) to obtain information that the data sources possess with respect to an end user associated with that identifier. As responses to the queries are received, they are filtered against a probability sample, which represents a set of respondents having demographic attributes consistent with the audience segment, to determine whether an end user (e.g., present in-location) should be included in a set of respondents. If so, an end user experience opportunity (e.g., a survey) is issued to the mobile device.

### BACKGROUND

### Technical Field

This application relates generally to consumer behavioral research and related measurement techniques.

### Brief Description of the Related Art

Market research is any organized effort to gather information about people or consumers and, in particular, to obtain their feedback about products and services in target markets. There are numerous methods and systems (e.g., panels, meters, pixels and the like) to quantify and understand the behavior and consumption patterns of audiences including in some instances mobile device users. Indeed, there are many well-known prior art techniques to facilitate mobile device-based surveys. In one typical online approach, the end user first downloads a survey application to his or her mobile device, and is then delivered an invitation to participate in an online-based study. The user may also receive an email link to the application from another user or from a company from which the user has purchased products or services or that performs market research. The application installs on the user's mobile device and allows the user to participate in one or more surveys for conducting market research or gathering other information. By installing the application, the user can run the application to view available surveys, and the application can use facilities of a mobile device platform, such as push notifications, to inform the user of new surveys. Information collected from the survey can then be exposed to interested entities. Often, these types of systems also attempt to incent end user participation in the market research by providing various benefits to the end users who participate. A representative approach of this type is described in U.S. Publication No. 2012/0173,305. Other mobile device location-based market research techniques and technologies are described in U.S. Pat. Nos. 7,092,964, 7,178,726, 8,612,426 and 9,569,692, among others. These mobile device-based advertising survey techniques also leverage web-based computing and services platforms, such as described in U.S. Publication No. 2015/0269604, which describes a system platform that enables entities to conduct mobile device market research into advertising effectiveness across varying media.

Known techniques for surveying using mobile samples suffer from several biases. A first issue is “non-response” bias. People who will agree to be tracked and answer questions are fundamentally different from those that do not. Unlike survey research that is based on sampling, the panel is a universe in and of itself, and this creates a bias in the data. To address this homogeneity, steps can be taken to reasonably adjust the data to make it fall in line with the total US population and this is done with most research projects across virtually all vendors.

A second bias is known as “response” bias. The notion here is that people do not always tell the truth. In cases where there is an incentive for a respondent to answer “correctly” (so to speak), this bias can have large ramifications. An example would be a respondent saying that he or she is located somewhere when this is not the case. To address this bias, steps can be taken to track relative data (e.g., x percent more people said they did this), or to ask questions to refine the response.

Lastly, known mobile sampling scheme suffer from quota bias. Often, and to avoid low hit rates, mobile location-based surveys take everyone they can get. If hit rates are high, however, there are often quotas established. This can lead to many issues depending on how cells get filled. For example, differences can occur based on a particular day of week or time of day that is surveyed before the quota is filled. Although these prior art techniques and systems have proven useful, there remains a need in the art to provide a more effective behavioral research platform.

### BRIEF SUMMARY

This disclosure describes a method, apparatus and computer program to facilitate consumer behavioral research from mobile device end users, namely actual people, using mobile probabilistic sampling. The techniques described herein preferably are implemented with respect to a network-accessible platform, such as a cloud-based behavior Research-as-a-Service (RaaS) that implements the below-described operations. Typically, the network-accessible platform is operated by or in association with a service provider that provides the behavioral research service to its customers (e.g., brands, advertisers and other persons or entities that have an interest in obtaining consumer behavioral research/insights from actual people).

In one embodiment, a method is provided to facilitate consumer behavioral research from end users, namely, actual people. In particular, and when necessary to find sufficiently qualified people (respondents) to meet an audience segment to be surveyed, mobile device data (e.g., device identifiers) with respect to mobile devices that are or have been in a location of interest are identified with respect to a specific time of day or other defined time period. Preferably, the platform processes information in effect to triangulate three (3) relevant variables, namely: end user, physical location, and time (typically, a “qualified” time period corresponding to an in-location time period and an associated post-visit time period). If, by virtue of detecting his or her mobile device, an end user is found to be present in-location (and/or within the defined post-visit time period), the end user is considered to be a “qualified” end user. If qualified respondents are needed for a particular audience segment, the platform then makes a determination whether to offer that qualified end user with an end user opportunity (the response to which will then be incorporated into the survey results). Whether an end user opportunity is then provided to the (otherwise) qualified (by device/location/time) end user depends on whether the platform already has a sufficient probability sample according to some metric, preferably a general population census.

Thus, and according to this disclosure, once qualified end users are identified (based on triangulation of device/location/time), the platform implements a probability sampling methodology to “select” those end users that will receive the actual end user opportunities. Depending on the nature of the audience segment, the platform may not need to identify and survey additional respondents (e.g., because it already has sufficient respondents who have returned responses); typically, however, this will not be the case, and thus the platform performs the following additional processing using a probability sampling method. A sampling method of this type preferably utilizes some form of random selection to assure that different units in the population (however defined) have equal probabilities of being chosen. A probability sampling approach that is based on a general population census produces a stable and predictable model that ensures random selection across the relevant end user population.

As such, the platform first qualifies end users as described (based on triangulating device, location and time data), and then—as necessary—it further filters the resulting set of potentially qualified respondents to produce the appropriate probability sample that ensures a predictable process of random selection and inclusion that adjusts for any bias. If, based on an audience segment at issue, respondents need to be identified, the platform does so (from the pool of qualified respondents) and issues the end user opportunities to the identified respondents. If suitable responses to those opportunities are received within still another relevant time period (e.g., 24-48 hours), they are included in the survey results that are then exposed to the platform customer (or other permitted third party).

The foregoing has outlined some of the more pertinent features of the subject matter. These features should be construed to be merely illustrative. Many other beneficial results and applications can be attained by applying the disclosed subject matter in a different manner or by modifying the subject matter as will be described.

### BRIEF DESCRIPTION OF THE DRAWINGS

For a more complete understanding of the subject matter and the advantages thereof, reference is now made to the following descriptions taken in conjunction with the accompanying drawings, in which:

FIG. 1 is a service provider platform from which behavioral research-as-a-service according to this disclosure is provided to mobile device users and platform customer entitities;

FIG. 2 is a representative mobile device by which an end user (a prospective respondent) receives and can act upon an end user experience opportunity as described herein;

FIG. 3 illustrates a representative interaction between, on the one hand, mobile device users, and, on the other hand, the services platform; and

FIG. 4 is a process flow that depicts how the platform qualifies a particular mobile device user as a qualified respondent with respect to an audience segment of interest using a probability sampling methodology.

### DETAILED DESCRIPTION

As described above, the approach herein provides an automated system that facilitates data collection from mobile devices, e.g., to facilitate consumer behavioral research studies.

The disclosed method may be practiced in association with a computing infrastructure comprising one or more data processing machines.

### Enabling Technologies

A representative infrastructure is a service platform that facilitates consumer behavioral research-as-a-service. While the particular nature of the research may vary, a typical research scenario or project involves research from end users (i.e., actual people, typically acting as consumers of some product or service), e.g., a study to comprehensively understand consumer spending behavior. An end user has a mobile device, and that mobile device may include a mobile device application (or “app”) or other similar technology that facilitates the service. An end user that downloads the mobile device app, engages the technology implemented and registers (or otherwise opts-in) to the service is sometimes referred to herein as a registered end user, or an “in-app” registered user. Other end users having mobile devices may participant as respondents with respect to a particular research inquiry in the manner described below. Entities (customers) that use the service platform typically include businesses, organizations, and the like. Typically, an entity initiates a consumer behavior or market research project (such as a survey) by configuring the project via a web-accessible service platform dashboard, as will be described.

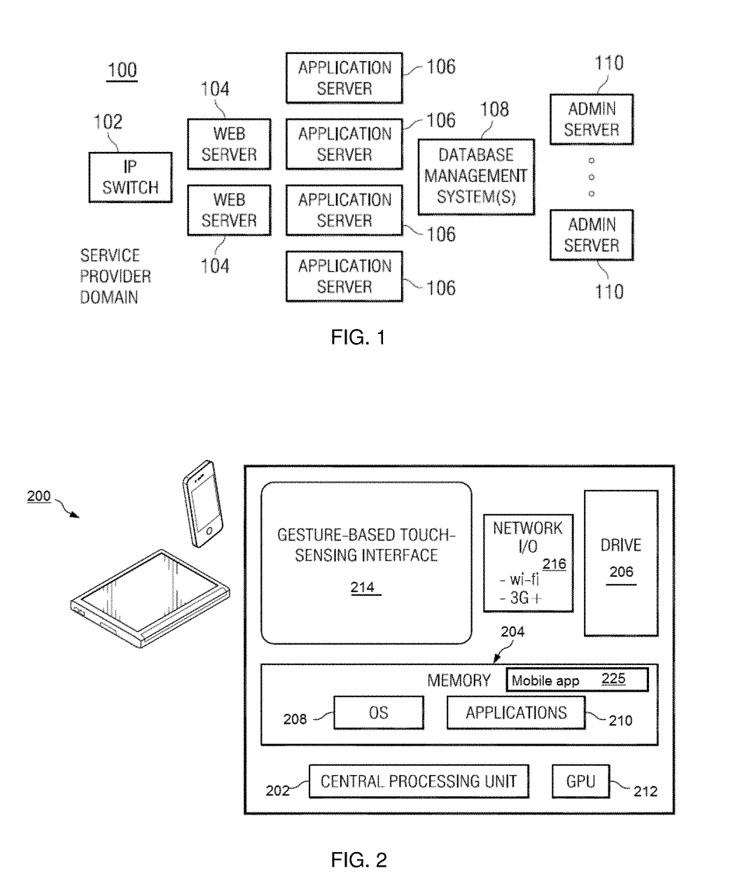

The service (in whole or in part) as described herein may be implemented on or in association with a service provider infrastructure 100 such as seen in FIG. 1. A representative infrastructure of this type comprises an Internet Protocol (IP) switch 102, a set of one or more web server machines 104, a set of one more application server machines 106, a database management system 108, and a set of one or more administration server machines 110. Without meant to be limiting, a representative technology platform that implements the service comprises machines, systems, sub-systems, applications, databases, interfaces and other computing and telecommunications resources. A representative web server machine comprises commodity hardware (e.g., Intel-based), an operating system such as Linux, and a web server such as Apache 2.5+ (or equivalent). A representative application server machine comprises commodity hardware, Linux, and an application server such as WebLogic 9.2+ (or equivalent). The database management system may be implemented as an Oracle (or equivalent) database management package running on Linux. The infrastructure may include a name service, FTP servers, administrative servers, data collection services, management and reporting servers, other backend servers, load balancing appliances, other switches, and the like. Each machine typically comprises sufficient disk and memory, as well as input and output devices. The software environment on each machine includes a Java virtual machine (JVM) if control programs are written in Java. Generally, the web servers handle incoming business entity provisioning requests, and they export a management interface. The application servers manage the basic functions of the service including, without limitation, business logic.

One or more functions of such a technology platform may be implemented in a cloud-based architecture approach. As is well-known, cloud computing is a model of service delivery for enabling on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. Available services models that may be leveraged in whole or in part include: Software as a Service (SaaS) (the provider's applications running on cloud infrastructure); Platform as a service (PaaS) (the customer deploys applications that may be created using provider tools onto the cloud infrastructure); Infrastructure as a Service (IaaS) (customer provisions its own processing, storage, networks and other computing resources and can deploy and run operating systems and applications).

The platform may comprise co-located hardware and software resources, or resources that are physically, logically, virtually and/or geographically distinct. Communication networks used to communicate to and from the platform services may be packet-based, non-packet based, and secure or non-secure, or some combination thereof.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines.

The front-end of the above-described infrastructure is also representative of a conventional web site (a set of web pages), and access to the site (or portions thereof) may be secured by conventional access controls including, without limitation, authentication and authorization mechanisms. Access to the site (or portions thereof) may require a secure connection, e.g., using a TLS/SSL-secured web page.

Typically, but without limitation, a client device is a mobile device, such as a smartphone, tablet (e.g., an iPhone® or iPad® or similar devices, e.g., from Google, Microsoft, Amazon, or others), a wearable computing device, or the like. Such a device comprises a CPU (central processing unit), computer memory, such as RAM, and a drive. The device software includes an operating system (e.g., Apple iOS, Google® Android™, or the like), and generic support applications and utilities. The device may also include a graphics processing unit (GPU). The mobile device also includes a touch-sensing device or interface configured to receive input from a user's touch and to send this information to processor. The touch-sensing device typically is a touch screen. The mobile device comprises suitable programming to facilitate gesture-based control, in a manner that is known in the art.

As seen in FIG. 2, a representative end user client device 200 comprises a CPU (central processing unit) 202, such as any Intel- or AMD-based chip, computer memory 204, such as RAM, and a drive 206 (e.g., Flash-based). The device software includes an operating system (e.g., Apple iOS, Google® Android™, or the like) 208, and generic support applications and utilities 210. The device may also include a graphics processing unit (GPU) 212. In particular, the mobile device also includes an input device or interface 214 configured to receive input from a user's touch or other gesture, and to send this information to processor 212. The input device typically is a touch screen, but this is not a limitation. The input device or interface 214 recognizes sensory inputs, such as touches or other gestures, as well as the position, motion and magnitude of inputs on the user interface. The device also includes network I/O support 216 to support network transport (WiFi, 3G+). In operation, the touch-sensing device detects and reports the touches to the processor 212, which then interpret the touches in accordance with its programming. Typically, the touch screen is positioned over or in front of a display screen, integrated with a display device, or it can be a separate component, such as a touch pad. The touch-sensing device is based on sensing technologies including, without limitation, capacitive sensing, resistive sensing, surface acoustic wave sensing, pressure sensing, optical sensing, and/or the like.

Other data input mechanisms, such as voice recognition, may be utilized in the device 200.

Generalizing, the mobile device is any wireless client device, e.g., a cellphone, pager, a personal digital assistant (PDA, e.g., with GPRS NIC), a mobile computer with a smartphone client, or the like. Other mobile devices in which the technique may be practiced include any access protocol-enabled device (e.g., a Blackberry® device, an Android™-based device, or the like) that is capable of sending and receiving data in a wireless manner using a wireless protocol. Typical wireless protocols are: WiFi, GSM/GPRS, CDMA or WiMax. These protocols implement the ISO/OSI Physical and Data Link layers (Layers 1 & 2) upon which a traditional networking stack is built, complete with IP, TCP, SSL/TLS and HTTP.

In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email, WAP, paging, or other known or later-developed wireless data formats. Generalizing, a mobile device as used herein is a 3G− (or next generation) compliant device that includes a subscriber identity module (SIM), which is a smart card that carries subscriber-specific information, mobile equipment (e.g., radio and associated signal processing devices), a man-machine interface (MMI), and one or more interfaces to external devices (e.g., computers, PDAs, and the like). The techniques disclosed herein are not limited for use with a mobile device that uses a particular access protocol. The mobile device typically also has support for wireless local area network (WLAN) technologies, such as Wi-Fi. WLAN is based on IEEE 802.11 standards.

The underlying network transport may be any communication medium including, without limitation, cellular, wireless, Wi-Fi, small cell (e.g., femto), and combinations thereof.

As noted above, the companion device is not limited to a mobile device, as it may be a conventional desktop, laptop or other Internet-accessible machine or device running a web browser, browser plug-in, or other application. It may also be a mobile computer with a smartphone client, any network-connected appliance or machine, any network-connectable device (e.g., a smart wrist device), or the like.

As also seen in FIG. 2, the mobile device includes a mobile app (or native application, or the like) 225 that implements the end user (client-side) functionality of the technique of this disclosure, which is now described. Preferably, the mobile app delivers an entertaining, location-based experience to enable an end user to share feedback during the user's normal routine. End users may be offered various incentives to facilitate their participation.

### Consumer Behavioral Research-as-a-Service Platform

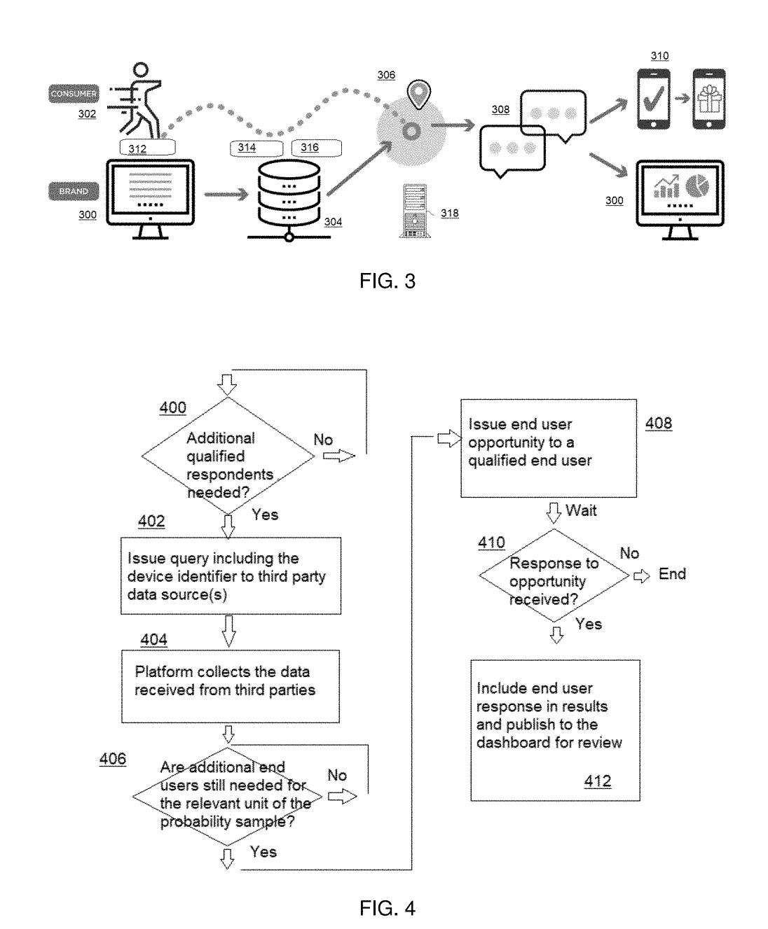

With the above as background, FIG. 3 illustrates the basic approach of this disclosure, which provides research-as-a-service, preferably using real-time dynamically-adjusted respondent sets identified in the manner described below. In this approach, as has been described above, a behavioral consumer research method and system are implemented. As depicted, the system comprises a network-accessible platform dashboard 300 that a consumer (customer) 302 of the service accesses. Typically, the dashboard is implemented via a web site front-end (e.g., accessible via SSL/TLS) configured as a set of web pages, and this front-end is associated with one or more backend application server(s), as well as one or more database server(s) and data stores. As depicted, these database server(s) and data stores comprise database 304. Consumers (customers) configured their research via the dashboard 300, typically by identifying one or more locations 306 for the desired research. As will also be described, the approach herein facilitates providing to certain mobile device end users the ability to participate in this research by receiving and acting upon end user experience opportunities (e.g., surveys) 308. Mobile device end users receive these opportunities on their mobile devices 310, and the data collected as a result of end users acting upon them is collected and exposed to the consumer via the dashboard as depicted.

Without intending to be limited, the various components of the system that are depicted in FIG. 3 (e.g., the network-accessible platform and dashboard, the associated database, and so forth) may be implemented in a cloud environment (e.g., Amazon EC2, Amazon RDS for SQL Server, Microsoft Azure, and many others). One or more sub-systems may be implemented within a virtual private cloud, in a hybrid cloud, in a standalone on-premises environment, in a virtualized environment, or the like.

To facilitate a research project, a data set 312 with respect to a behavioral research project is first received and stored in the database 304 at or in association with the platform. Typically, the data set is received from the customer 302 of the service. The data set comprises an audience segment, one or more physical locations 306 that the customer is interested in evaluating/researching behavioral trends, and the “end user experience” 308. As used herein, an “end user experience” preferably involves an end user (having a mobile device) undertaking one or more of the following activities: taking a survey, viewing given content, uploading a photo or video, leaving a comment, and sharing information via a social network. Thus, for example, when end users participate in taking a consumer behavior study/survey (as one type of end user experience), the system collects and aggregates responses from the end users and provides survey results to the service customer, e.g., through the dynamic, real-time web-accessible dashboard 300, a raw data reporting file, or the like. The platform preferably exposes to the customer one or more end user experience(s), and the consumer associates a given end user experience opportunity to a particular research project being configured by the consumer using the dashboard.

In addition to provisioning the data set, the method also includes receiving and storing so-called first party data 314 associated with each of a plurality of end users. These end users are those that have downloaded and installed on their mobile devices a mobile application (or “app” 225, in FIG. 2) provided by the service provider (or from an alternative source, such as an application store, as authorized by the service provider). Preferably, the first party data 314 for a given end user is one of: user-provided profile data (submitted by the end user on the mobile app, in which case the user is sometimes referred to as an “in-app respondent”), or it may be similar data supplied some third party has obtained from the end user (so-called “third party-supplied profile data”). In either case, typically the profile data includes the device identifier for the mobile device, the device's location, and a defined time period.

In the approach herein, there are several time periods of interest, and these are differentiated as follows.

A first (1^{st}) time period is the overall time period for a particular study. This first time period is sometimes referred to as the “flight” date, and typically this period is relatively lengthy, such as thirty (30) days. This period represents the overall period during which relevant end users are being identified and surveyed. This first time period typically does not have any location-specific component or aspect.

A second (2^{nd}) time period refers to a time period associated with a particular location of interest. This second time period is one for which the platform identifies anyone (by their mobile device identifier) that has visited the particular location of interest (e.g., a given retail outlet store) during the relevant time period, which is usually (but not necessarily) coincident with the flight time period. Thus, for example, the second time period may be 30 days in length, and it may have associated therewith a set of mobile device identifiers (corresponding to registered mobile device users that have visited the location of interest during that second time period). There may be multiple second time periods associated with a particular first time period, and each second time period may have a unique location associated therewith.

A third (3^{rd}) relevant time period refers to a time period (e.g., 24-48 hours) in which a person who has been qualified by the platform as a respondent has to provide a timely response to a particular end user experience that has been tendered to the end user for response.

Typically, the third time period refers to the period during which any response received by the platform (from the qualified end user) will be counted by the platform.

A fourth (4^{th}) relevant time period refers to a relatively shorter time period (e.g., 1-2 hours) corresponding to a time period after an end user visits a location of interest (as determined by the user's mobile device identifier being obtained and provided back to the platform during the fourth time period). This time period is also referred to herein as “post-visit” or “after visit” period, and it corresponds to a period during which the platform may still validly deliver (to the end user) an end user opportunity. Preferably, a technical and procedural goal of the platform (as described below) is to deliver the end user opportunity to the mobile device user either in-location (i.e., when the mobile device is physically present) or within the fourth time period (e.g., at most 1-2 hours post-visit). Once the end user timely receives the end user opportunity, a response received within the third time period (e.g., 24-48 hours) is then counted in the survey results.

A fifth (5^{th}) relevant time period refers to the often relatively shorter time period during which the end user mobile device is actually physically present in a particular location of interest.

Of course, the length of any or all of the above-identified time periods may vary. As described above, typically a particular 5^{th} time period (corresponding to a device being in-location) may have an associated 4^{th} time period (corresponding to some set time period “post-visit”). The combination of the 4^{th} and 5^{th} time periods is sometimes referred to herein as a “qualified” time period, referring to a time period during which an end user may be deemed (by the platform) to be a “qualified” respondent.

As will be described, preferably the platform processes information in effect to triangulate three relevant variables, namely: end user, physical location, and time (typically the “qualified” time period corresponding to the 5th time period (in-location) and/or its associated 4th time period (post-visit)). If, and by virtue of detecting his or her mobile device, an end user is present in-location (and/or within the defined post-visit) time period, the end user is a “qualified” end user.

If qualified respondents are needed for a particular audience segment, the platform then makes a determination whether to engage with that user, namely, to offer that qualified end user with an end user opportunity (the response to which will then be incorporated into the survey results. Whether an end user opportunity is then provided to the (otherwise) qualified (by device/location/time) end user depends on whether the platform already has a sufficient probability sample according to some metric, preferably a general population census.

According to this disclosure, once qualified end users are identified, the platform implements a probability sampling methodology to “select” those end users that will receive the actual end user opportunities. Depending on the nature of the audience segment, the platform may not need to identify and survey additional respondents (e.g., because it already has sufficient respondents who have returned responses); typically, however, this will not be the case, and thus the platform performs the following additional processing as necessary. In particular, and as used herein, a probability sampling method is any method of sampling that utilizes some form of random selection that assures that different units in the population (however defined) have equal probabilities of being chosen. A probability sampling approach that is based on a general population census produces a stable and predictable model that ensures random selection across the relevant end user population.

As such, the platform first qualifies end users as described (based on triangulating device, location and time data), and then—as necessary—it further filters the resulting set of potentially qualified respondents to produce the appropriate probability sample that ensures a predictable process of random selection and inclusion that adjusts for any bias. If, based on an audience segment at issue, respondents need to be identified, the platform does so (from the pool of qualified respondents) and issues the end user opportunities to the identified respondents.

Thus, there may be many end users who are “qualified,” but not all such users are necessarily selected to receive end user opportunities. Whether a particular qualified end user obtains an end user opportunity, or whether that user's response to that opportunity is then counted by the platform in the survey results, preferably depends as well on the probability sampling.

To this end, and referring back to FIG. 3, the following provides additional details regarding this methodology. In addition to provisioning the data set and obtaining/receiving the first party data associated with the plurality of end users, the platform also receives or obtains and stores “location data” 316. Typically, the location data 316 is sourced from a location-based data source 318 or, in some cases, directly from mobile devices users (in the case of in-app registered users), or from any other mobile application location data sources. The location data 316 identifies, for each of the one or more physical locations (that may be specified or provisioned in the data set of a service customer), a device identifier associated with a mobile device that is or has been present in the physical location.

With the above-described information present in or otherwise available to the platform, the following operations are then carried out to facilitate a behavioral research project (provided by the platform on behalf of a given service customer) and, in particular, when it is necessary to find sufficiently qualified respondents to meet an audience segment with respect to a given location and in a defined time period (e.g., the 4^{th} and 5^{th} time periods identified above) that is desired to be surveyed. These operations are depicted in the process flow shown in FIG. 4. Preferably, and to the extent possible, the people who will be surveyed are obtained from in-app respondents. This is not a limitation, however. Of course, it is presumed that there are multiple service customers who share the services platform, and thus the following operations preferably are carried out for each such project (e.g., for each such service customer). Of course, for any particular customer there may be multiple such surveys being carried out concurrently, including a particular survey associated to a particular location. Indeed, multiple survey customers may carry out distinct surveys with respect to their distinct products (even when offered from a same location).

The following describes a representative operation of the service platform for a particular entity for which the platform is executing a survey with respect to a particular product/service associated with a given location. The process begins at step 400. In particular, and during the 1st time period (the in-flight period), and with respect to any device identifier received from the location-based data source that matches a device identifier in the first party data, a determination is made whether the platform needs to identify qualified respondents (that will receive end user opportunities). If the outcome of this test is negative, the routine cycles. If, however, the determination is that the platform needs to identify qualified respondents, at step 402 a query that includes the device identifier is issued to one or more third party data sources. The third party data sources may be of many different types including, without limitation, data management platforms, publisher networks, supply side platforms, others networks and exchanges, and the like. The purpose of issuing the query is to attempt to obtain information that any of the one or more third party data sources possesses with respect to an end user associated with that device identifier. The information typically comprises the device identifier and one or more demographic attributes associated with the end user associated with the device identifier. The routine then cycles at step 404, which represents the platform receiving responses to the queries; preferably, step 404 is carried out during the 4^{th} or 5^{th} time periods such that mobile devices in-location (or post-visit) can be identified.

With respect to the qualified time period, and as responses to queries to the one or more third party data sources are received, at step 404 the platform collects the relevant end user data that is received. As noted above, the information also includes the device identifiers for the mobile devices (and thus mobile device end users) who were in-location (or present post-visit). As such, the associated end users are “qualified” in the sense that they satisfy the end user (device)/location/time requirement. At step 406, a determination is then made whether further respondents (for each of the relevant units of the probability sample) are still required. If the outcome of the test at step 406 (for any unit of the probability sample) is negative, the routine cycles. If, however, the outcome of the test at step 406 indicates that additional respondents are still needed, the routine continues at step 408 to issue an end user opportunity to a qualified end user (and in particular to the mobile device identifier). Typically, the end user opportunity is identified in a text (e.g., SMS or MMS) message delivered to the mobile device. In the alternative, the end user opportunity is delivered by e-mail, voice call, or other data delivery technique.

A particular end user opportunity has an associated 3^{rd} time period representing the period of time during which the platform must receive an appropriate response to the end user opportunity in order for the response to be taken into consideration (in the survey results). Thus, at step 410, and for each end user opportunity, a test is carried out to determine whether a response to the end user opportunity has been received. If not, the routine branches and terminates (as the particular end user response (if it comes later) is not counted or considered. Control then branches back to step 406 to determine whether additional respondents (for a particular probability sample unit) are still required. If, however, the end user responds to the end user opportunity within the 3^{rd} time period, the routine continues at step 412 to include the response in the survey results. Typically, the end user response is aggregated with results from other qualified respondents (which collectively form a survey “panel”). This completes the processing.

Different end user opportunities may have different 3^{rd} time periods associated with them. Moreover, while the 3^{rd} time period preferably is uniform, in certain circumstances a particular 3^{rd} time period may vary with respect to a particular probability sample unit. Thus, some qualified respondents may be given more time to respond to an end user opportunity than other qualified respondents.

As previously noted, the probability sample methodology herein ensures that a stable and predictable model that ensures random selection of relevant respondents (each of whom are first “qualified”) is used to build the desired audience segment. In particular, the probability sample represents a set of respondents having demographic attributes that are consistent with the audience segment, and the filtering (or qualified end users) is used to determine whether an actual end user (who is actually present in the physical location at the qualified time period) is included in the set of respondents that receive the end user oppportunity. Upon a determination that the actual end user is both qualified (because he or she meets the required demographic attributes and is present in the physical location during the qualified time period) and further because the platform needs to identify an additional respondent to survey, an end user that meets all of these requirements is then offered the end user opportunity. Whether the end user is such an additional respondent preferably depends on the probability sampling methodology that is based on a general population census and a predictable process of random selection and inclusion that adjusts for bias with respect to such a population.

Thus, based on the information provided by the third party data sources, the platform “knows” what mobile devices (based on their device identifiers) are in or at a relevant physical location. The probability sample in effect adapts to who is in the network at the relevant time (and typically this sample changes in real-time), and end users come in and then leave the audience dynamically. The probability sample controls for known biases, and preferably this sample also is adjusted to account for known biases (e.g., derived from census or other data).

In particular, the approach herein preferably identifies actual people (versus clicks or impressions that do not represent people) to include in the research project based on the combination of device identifier, location, time and random selection of population, preferably based on census data. This methodology preferably is carried out in a continuous process and, as such, is adjusting in real-time based on the users who are engaging a specific consumer behavior research project at a given time or time period. As noted, ultimately the probability sample determines whether to serve the end user experience (to end users who are otherwise “qualified” by device/location/time), and preferably the experience is delivered (to the qualified users) at a time that is most appropriate for obtaining useful information, namely, during or just after the end user's visitation to a location of interest.

As depicted, the probability sample layer (which in effect sits between a “bid” and “response” in a conventional ad impression/click-based approach) enables the system to identify actual people to query, and it facilitates the system making a real-time bid decision based on the probability sample. Preferably, this is an on-going (continuous) process that ensures a high quality and accurate sample, namely, that people of interest (as opposed to automated mechanisms such as spiders, bots, user agents, etc.) are actually responding. The approach avoids fraud or other gaming of the research, which can occur when such automated mechanisms provide all (e.g., clicks or impressions) that the system may request; here, the end user experience (e.g., filling out a survey form at a particular time and in-location) ensures that the research cannot be manipulated.

To be able to project results, sampling requires a known non-zero probability of selection. The technique described herein provides a method of systematically sub-sampling (where not everyone is taken) the respondents such that there are known probabilities of selection, and thus the data can be weighted and projected to the total panel. If necessary, the results can also be weighted programmatically to adjust for any non-response bias of the panel.

The techniques herein thus provide significant advantages. Qualified respondents (end users) share their in-location experiences via mobile device, and brands (platform customers) receive response and reactions in real-time through a dynamic dashboard. Brands are able to identify and interact with and learn from people as respondents, rather than a media campaign delivery impressions or clicks, which is an approach that is inefficient and not effective for consumer behavioral research purposes. Consumer experiences, responses, and reactions are presented in an easy to digest format through this web-based real-time tool. The client user can quickly access key information, filter data and analyze results to inform appropriate response. Reporting can be delivered via a dynamic dashboard, by standard CSV or SPSS file formats, documented web services, email or printed PDF version. The platform database is the central repository for people/user profile data, response, location and time period specification and information. As has been described, the data can be used to deliver personalized activities and experiences to people or analytics about specific communities of people and first party audiences. The cloud-based architecture comprises a system for data collection, processing and machine learning techniques.

The Research-as-a-Service methodology enables companies (or other interested parties) to gain access to a broad audience and general consumer spending behavior perspective, and not just from a Company's consumer base. Rather, and in part due to use of the probability sampling methodology based on the general population census, the results are based on a first party audience that is nationally-representative and statistically significant. Preferably, the service is provided on a subscription basis, e.g., that can be used to deliver ongoing monthly responses, while in-location, and responses are delivered through the client dashboard. This project-based research approach provides companies rapid access to consumer response and reaction while consumers are in-location (or just before or just after), physically engaging products and services. Research projects may also be conducted on an ad-hoc basis to inform specific strategic objectives or insights for products and services in market.

The platform provides a valuable consumer behavior insight tool to provide deeper knowledge from a larger sample of actual consumers to augment corporate systems and furnish a more holistic view of the consumer, including behavioral patterns and other impacts on consumer spending and purchasing habits.

A further advantage is provided by the above-described mobile first approach for interacting with people across the country at scale, in-location and in real-time enables generation of deterministic data that delivers unparalleled breadth and depth. The system-based technology approach incorporates proven market research principles and media ratings standards to create a probability sample, which allows the services platform to observe people while in-location, defining baseline metrics and measure audiences. As described, preferably the demographics and cooperation rates are adjusted using this probability sample method to deliver confidence to clients who are subscribing to obtain the syndicated and custom research services.

More generally, the techniques described herein are provided using a set of one or more computing-related entities (systems, machines, processes, programs, libraries, functions, or the like) that together facilitate or provide the described functionality described above. In a typical implementation, a representative machine on which the software executes comprises commodity hardware, an operating system, an application runtime environment, and a set of applications or processes and associated data, that provide the functionality of a given system or subsystem. As described, the functionality may be implemented in a standalone machine, or across a distributed set of machines. The functionality may be provided as a cloud-based service, e.g., as a SaaS solution.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While the disclosed subject matter has been described in the context of a method or process, the subject disclosure also relates to apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While given components of the system have been described separately, one of ordinary skill will appreciate that some of the functions may be combined or shared in given instructions, program sequences, code portions, and the like.

There is no limitation on the type of computing entity that may implement the functionality described herein. Any computing entity (system, machine, device, program, process, utility, or the like) may be used.

While given components of the system have been described separately, one of ordinary skill will appreciate that some of the functions may be combined or shared in given instructions, program sequences, code portions, and the like. Any application or functionality described herein may be implemented as native code, by providing hooks into another application, by facilitating use of the mechanism as a plug-in, by linking to the mechanism, and the like.

The approach herein of using in-location provided mobile device identifiers, and then using those identifiers to facilitate a query-response mechanism using both device/location/time “qualification” together with a probability sampling methodology provides significant computational and infrastructure efficiencies for the services platform, while significantly reducing memory and storage requirements (at least in part because queries are streamlined in the first instance using the device identifier-specific query technique). The computational and memory/storage efficiencies provided in this manner with respect to a given research project then facilitate the use of the services platform to provide similar operations with respect to multiple, concurrently-executing projects that each are carried out in a similar manner (but with respect to different audience segments, different physical locations, different sets of mobile devices users, etc.), all in a computationally- and storage-efficient manner even as the platform operates research projects concurrently. The platform-based approach as described significantly reduces the cost of delivery infrastructure as compared to prior techniques that require separate and dedicated systems for data collection, logging, device identification, and the like.

What is claimed is as follows:

1. A method to improve a computational efficiency of a computing system that generates behavioral research from end users, wherein an end user has an associated mobile device having a device identifier, comprising:
receiving and storing a data set with respect to a behavioral research project, the data set comprising an audience segment, a physical location, and an end user experience;
receiving first party data associated with each of a plurality of end users, the first party data for a given end user being one of: user-provided profile data, and third party-supplied profile data that the third party has obtained from the end user, wherein the profile data includes the device identifier for the mobile device associated with the end user;
receiving location data from a location-based data source, the location data identifying, for each of the one or more physical locations, a device identifier associated with a mobile device that is or has been present in the physical location;
for a given time period, and with respect to any device identifier received from the location-based data source that matches a device identifier in the first party data, issuing a query that includes the device identifier to one or more third party data sources, thereby obtaining information that any of the one or more third party data sources possesses with respect to an end user associated with that device identifier, the information comprising the device identifier and one or more demographic attributes associated with the end user associated with the device identifier;
with respect to the given time period, and as responses to queries to the one or more third party data sources are received, filtering a given response against a probability sample representing a stable, randomly-selected set of respondents having demographic attributes that are consistent with the audience segment and census population to determine whether an actual end user associated with the given response and that is or was present in the physical location during the given time period should be included in the set of respondents to engage the end user experience; and
upon a determination that the actual end user should be included in the set of respondents, issuing an end user experience opportunity to the mobile device associated with the device identifier returned in the given response;
wherein, based at least upon the issuing and filtering operations, the probability sample adapts dynamically to actual end users of the audience segment that are available during the given time period, thereby providing improved computational efficiency of the computing system.

2. The method as described in claim 1 further including dynamically and continuously adjusting one or more weights in the probability sample based at least in part on end users associated with the first and third party data sources.

3. The method as described in claim 1 wherein the end user experience opportunity is one of: taking a survey, viewing given content, uploading a photo or video, leaving a comment, and sharing information via a social network.

4. The method as described in claim 1 wherein when the end user experience opportunity is taking a survey, the method further includes receiving an end user response to the survey.

5. The method as described in claim 4 further including:
determining whether a sufficient number of end user responses to the survey have been received; and
when a sufficient number of end user responses to the survey remain outstanding, aggregating the end user response with end user responses from other end users that have been qualified in the set of respondents.

6. The method as described in claim 5 further including generating and outputting survey results from the end user responses that have been aggregated after the given time period.

7. The method as described in claim 6 wherein the survey results are further normalized against a probability sample that represents a given demographic sample based on general population census representation.

8. The method as described in claim 1 wherein the first party data is obtained from end users via a mobile device application.

9. The method as described in claim 1 wherein the first and third party-supplied profiled data is obtained from one or more of the data sources.

10. The method as described in claim 1 wherein the location data also includes a location identifier, a dwell-time, and a timestamp.

11. The method as described in claim 1 wherein the end user experience opportunity is issued as a responsive URL to the end user's mobile device.

12. The method as described in claim 1 wherein the end user experience opportunity includes at least one in-location experience question associated.

13. The method as described in claim 1 wherein a set of end users that comprise an audience segment varies dynamically and is unconfined to a finite panel population.

14. The method as described in claim 1 wherein the third party data sources comprise one of: a data management platform, a publisher platform, and a supply side platform.

15. Apparatus, to generate behavioral research in a computationally-efficient manner from end users having mobile devices, wherein an end user has an associated mobile device having a device identifier comprising:
one or more hardware processors;
computer memory storing computer program code configured to be executed in the one or more hardware processors to:
receive and store a data set with respect to a behavioral research project, the data set comprising an audience segment, one or more physical locations, and an end user experience;
receive first party data associated with each of a plurality of end users, the first party data for a given end user being one of: user-provided profile data, and third party-supplied profile data that the third party has obtained from the end user, wherein the profile data includes the device identifier for the mobile device associated with the end user;
receive location data from a location-based data source, the location data identifying, for each of the one or more physical locations, a device identifier associated with a mobile device that is or has been present in the physical location;
for a given time period, and with respect to any device identifier received from the location-based data source that matches a device identifier in the first party data, issue a query that includes the device identifier to one or more third party data sources, thereby obtaining information that any of the one or more data sources possesses with respect to an end user associated with that device identifier, the information comprising the device identifier and one or more demographic attributes associated with the end user associated with the device identifier;
during the given time period, and as responses to queries to the one or more third party data sources are received, filter a given response against a probability sample representing a set of respondents having demographic attributes that are consistent with the audience segment and that are or were present in the physical location to determine whether an actual end user associated with the given response should be included in the set of respondents; and
upon a determination that the actual end user should be included in the set of respondents, issue an end user experience opportunity to the mobile device associated with the device identifier returned in the given response;
wherein, based at least upon the issue a query and filter operations, the probability sample adapts dynamically to actual end users of the audience segment that are available during the given time period, thereby providing improved computational efficiency of the apparatus.

16. The apparatus as described in claim 15 wherein the end user experience opportunity is one of: taking a survey, viewing given content, uploading a photo or video, leaving a comment, and sharing information via a social network.

17. The apparatus as described in claim 16 wherein, when the end user experience opportunity is taking a survey, the computer program code is further configured to:
receive end user responses to the survey;
determine whether a sufficient number of end user responses to the survey have been received;
when a sufficient number of end user responses to the survey remain outstanding, aggregate the end user response with end user responses from other end users that have been qualified in the set of respondents; and
generate and output survey results from the end user responses that have been aggregated after the given time period.

18. A computer program product in a non-transitory computer readable medium, the computer program product holding computer program instructions executed by a computing system to generate behavioral research in a computationally-efficient manner from end users having mobile devices, wherein an end user has an associated mobile device having a device identifier, the computer program instructions comprising program code configured to:
receive and store a data set with respect to a behavioral research project, the data set comprising an audience segment, one or more physical locations, and an end user experience;
receive first party data associated with each of a plurality of end users, the first party data for a given end user being one of: user-provided profile data, and third party-supplied profile data that the third party has obtained from the end user, wherein the profile data includes the device identifier for the mobile device associated with the end user;
receive location data from a location-based data source, the location data identifying, for each of the one or more physical locations, a device identifier associated with a mobile device that is or has been present in the physical location;
for a given time period, and with respect to any device identifier received from the location-based data source that matches a device identifier in the first party data, issue a query that includes the device identifier to one or more third party data sources, thereby obtaining information that any of the one or more data sources possesses with respect to an end user associated with that device identifier, the information comprising the device identifier and one or more demographic attributes associated with the end user associated with the device identifier;
during the given time period, and as responses to queries to the one or more third party data sources are received, filter a given response against a probability sample representing a set of respondents having demographic attributes that are consistent with the audience segment and that are or were present in the physical location to determine whether an actual end user associated with the given response should be included in the set of respondents; and
upon a determination that the actual end user should be included in the set of respondents, issue an end user experience opportunity to the mobile device associated with the device identifier returned in the given response;
wherein, based at least upon the issue a query and filter operations, the probability sample adapts dynamically to actual end users of the audience segment that are available during the given time period, thereby providing improved computational efficiency of the computing system.
